(19) United States
(12) Patent Application Publication
(10) Pub. No.: US 2026/0244086 A1
(43) Pub. Date: Aug. 20, 2026

(54) LIGHT SOURCE APPARATUS AND PROJECTION-TYPE IMAGE DISPLAY APPARATUS

(71) Applicant: Panasonic Projector & Display Corporation, Osaka (JP)

(72) Inventors: Takashi IKEDA, Osaka (JP); Manabu Okuno, Osaka (JP); Michihiro Okuda, Osaka (JP); Yusaku Nishikawa, Osaka (JP)

(21) Appl. No.: 19/648,301

(22) Filed: Apr. 15, 2026

Related U.S. Application Data
(63) Continuation of application No. PCT/JP2024/036447, filed on Oct. 11, 2024.

(30) Foreign Application Priority Data
Oct. 16, 2023 (JP) 2023-178395

(51) Int. Cl. G03B 21/20

(52) U.S. Cl. CPC G03B 21/204

(57) ABSTRACT

A light source apparatus includes a light source, a first wavelength selection element, a light-collecting element, a second wavelength selection element, a wavelength conversion element. The first wavelength selection element is disposed at a position where the first light is incident and having a reflective portion that reflects the first light and a transmissive portion that transmits the first light, the first wavelength selection element transmitting a second light. The light-collecting element is disposed at a position to receive the first light reflected by the first wavelength selection element. The second wavelength selection element transmits or reflects, depending on its rotation state, the first light collected by the light-collecting element. The first light incidence on the second wavelength selection element and the first light reflected by the second wavelength selection element pass through spatially different positions in the light-collecting element.

### CROSS REFERENCE TO RELATED APPLICATION

This is a continuation application of International Application No. PCT/JP2024/036447, with an international filing date of Oct. 11, 2024, which claims priority of Japanese Patent Application No.2023-178395 filed on Oct. 16, 2023, the content of which is incorporated herein by reference.

### BACKGROUND

### Technical Field

The present invention relates to a light source apparatus and a projection-type image display apparatus.

### Background Art

Conventionally, there have been light source apparatus that irradiate excitation light onto a phosphor wheel to generate fluorescent light, which then passes through a color wheel to generate red light, green light, and yellow light. For example, JP2014-186081A proposes a light source apparatus that uses a blue semiconductor laser to generate fluorescent light, which passes through a color trim hole (color wheel).

### SUMMARY

However, in the light source apparatus of Patent Document 1, in addition using blue light as excitation light for generating fluorescent light, the blue light is passed through the blue transmission region of the phosphor wheel, then looped and incidence on the color trim hole to be used as blue light. Accordingly, a space for looping the blue light is required, which hinders the size reduction of the light source apparatus.

An object of the present disclosure is to provide a light source apparatus and a projection-type image display apparatus that can be reduced in size.

A light source apparatus according to the present disclosure comprises: a light source that emits a first light having a first wavelength range; a first wavelength selection element disposed at a position where the first light is incident and having a reflective portion that reflects the first light and a transmissive portion that transmits the first light, the first wavelength selection element transmitting a second light having a second wavelength range different from the first wavelength range; a light-collecting element disposed at a position to receive the first light reflected by the first wavelength selection element; a second wavelength selection element that transmits or reflects, depending on its rotation state, the first light collected by the light-collecting element; and a wavelength conversion element having a wavelength conversion segment that wavelength-converts the first light reflected by the second wavelength selection element into the second light. The first light incidence on the second wavelength selection element and the first light reflected by the second wavelength selection element pass through spatially different positions in the light-collecting element.

A projection-type image display apparatus according to the present disclosure comprises the light source apparatus described above.

The present disclosure can provide a light source apparatus and a projection-type image display apparatus that can be reduced in size.

### BRIEF DESCRIPTION OF DRAWINGS

FIG. 1 is an overall view showing the configuration of a light source apparatus according to a first embodiment;

FIG. 2 is a view from the normal direction of a mirror;

FIG. 3A is a front view of a phosphor wheel;

FIG. 3B is an explanatory diagram illustrating the sum of the central angles of segments of the phosphor wheel;

FIG. 4 is a rear view of a color wheel disc at the initial position in a first rotation mode;

FIG. 5 is an explanatory diagram illustrating the first rotation mode in which the color wheel and the phosphor wheel rotate synchronously;

FIG. 6 is a rear view of the color wheel disc at the initial position in a second rotation mode;

FIG. 7 is an explanatory diagram illustrating the second rotation mode in which the color wheel and the phosphor wheel rotate synchronously;

FIG. 8 is a front view of a phosphor wheel according to a second embodiment;

FIG. 9 is an explanatory diagram illustrating a first rotation mode in which the color wheel and the phosphor wheel rotate synchronously according to the second embodiment;

FIG. 10 is an explanatory diagram illustrating a second rotation mode in which the color wheel and the phosphor wheel rotate synchronously according to the second embodiment;

FIG. 11 is an overall view showing the configuration of a light source apparatus according to a third embodiment;

FIG. 12 is an overall view showing the configuration of a projection-type image display apparatus according to a fourth embodiment; and

FIG. 13 is an overall view showing the configuration of a light source apparatus according to a fifth embodiment.

### DESCRIPTION OF EMBODIMENTS

Embodiments will now be described in detail with reference to the drawings as appropriate. However, excessively detailed explanations may be omitted. For example, detailed descriptions of well-known matters or repeated explanations of substantially the same configurations may be omitted. This is to avoid unnecessary redundancy in the following description and to facilitate understanding by those skilled in the art.

The accompanying drawings and the following description are provided to enable those skilled in the art to fully understand the present disclosure, and are not intended to limit the subject matter defined in the claims.

### First Embodiment

### 1-1. Configuration of Light Source Apparatus

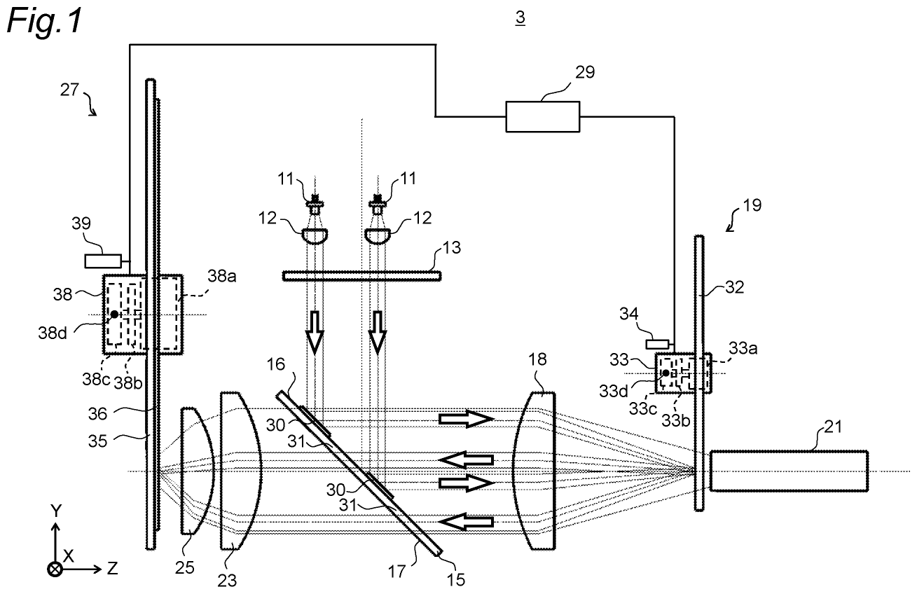

Referring to FIG. 1, a light source apparatus 3 of a first embodiment will described. FIG. 1 is an overall view showing the configuration of the light source apparatus 3 according to the first embodiment. In each drawing, the plane in which a color wheel disc 32 receives light is defined as the XY plane, and the direction orthogonal to the XY plane is defined as the Z direction. The direction in which light is emitted from the color wheel disc 32 is defined as the positive Z direction, and the viewpoint from the positive Z direction is defined as the front view.

As shown in FIG. 1, the light source apparatus 3 of the first embodiment is, for example, a light source apparatus for a one-chip digital micromirror device (DMD) type projection image display apparatus that uses one DMD. The light source apparatus 3 includes a plurality of laser light sources 11, a mirror 15 as a first wavelength selection element, a color wheel 19 as a second wavelength selection element, and a phosphor wheel 27 as a wavelength conversion element. The light source apparatus 3 also includes a convex lens 18, a rod integrator 21, convex lenses 23 and 25, and a controller 29.

Each of the plurality of laser light sources 11 emits first light having a first wavelength range, for example, blue light, which is laser light in a blue wavelength range. The blue light having a wavelength range component of, for example, 400 nm or more and less than 500 nm as the blue wavelength range, is collimated by a collimator lens 12 disposed corresponding to each of the laser light sources 11. The collimated first light is incidence on a diffusion plate 13, is diffused therein, and is thereby broadened in beam width so as to be converted into parallel light. The blue light emitted from the diffuser plate 13 is incidence on the mirror 15 arranged at an angle of approx. 45 degrees with respect to the optical axis.

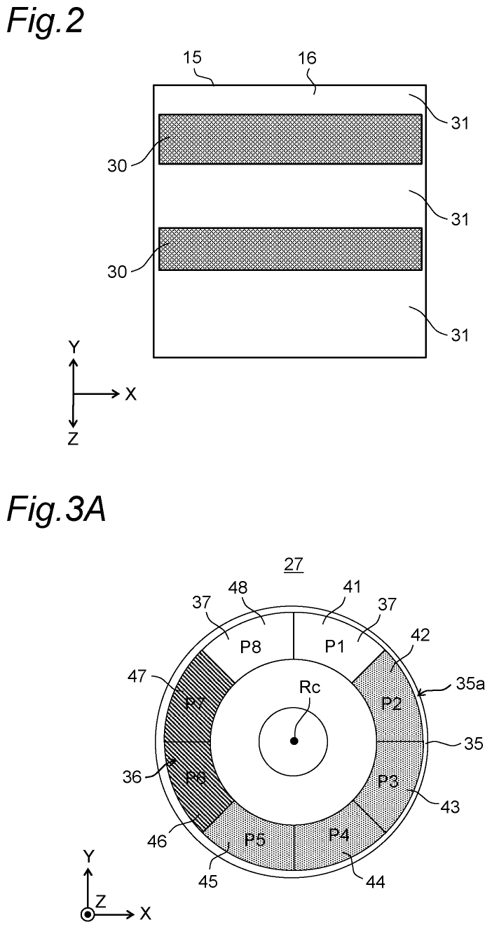

The mirror 15 is, for example, a glass or sapphire substrate, and has, for example, a rectangular shape as shown in FIGS. 1 and 2. The mirror 15 has a first main surface 16 and a second main surface 17. The first main surface 16 faces the laser light sources 11 and the color wheel 19, while the second main surface 17 faces the phosphor wheel 27. Note that the material and shape of the mirror 15 are merely examples and are not limited thereto.

The mirror 15 has a reflective portion 30 that reflects the blue light incident from the laser light source 11 and a transmissive portion 31 that transmits light in the visible light wavelength range, including blue light. The band-shaped reflective portion 30 has a reflective layer that reflects only light in the blue wavelength range, arranged on the first main surface 16, and is disposed in an area where the blue light incident from the laser light sources 11 illuminates. The reflective layer is, for example, a dichroic coat made of a dielectric layer that has reflective characteristics in the blue light wavelength range. The mirror 15 has two or more reflective portions 30, and by arranging the laser light source 11 corresponding to each reflective portion 30, two or more optical paths for the blue light heading toward the color wheel 19 can be implemented.

The convex lens 18 serving as a light-collecting element is disposed between the mirror 15 and a color wheel disc 32. The convex lens 18 collects light incident from the mirror 15 side at a predetermined position on the color wheel disc 32. When blue light reflected by the color wheel disc 32 enters the convex lens 18, its direction of travel is changed and it is emitted toward the mirror 15.

The color wheel 19 includes the color wheel disc 32, a motor 33 coupled to the color wheel disc 32 and driving the color wheel disc 32 to rotate, and a sensor 34 that detects the rotational phase of the motor 33. The color wheel disc 32 is, for example, a light-transmitting glass plate, and is held with a plurality of filters having a property that transmits blue light and some or all of the wavelength ranges of fluorescent light according to the characteristics of the optical system. The color wheel 19 transmits or reflects the blue light focused by the convex lens 18 depending on its rotation state. The color wheel 19 is controlled by the controller 29 to rotate synchronously with the phosphor wheel 27. The blue light that has passed through the color wheel disc 32 enters the rod integrator 21.

The motor 33 includes a hub 33a, a stator 33b, and a rotor 33c. The hub 33a is made of metal and is integrally coupled to the color wheel disc 32. The hub 33a has a metal portion, also called a counterbalance, made of e.g., aluminum, for balancing the rotation. This counterbalance is implemented by increasing or decreasing the weight of a portion. A marker 33d for synchronization with the phosphor wheel 27 is disposed at a predetermined location on the peripheral surface of the rotor 33c. The marker 33d is, for example, a black label.

The sensor 34 detects the rotational phase of the motor 33. The sensor is, for example, a reflective optical sensor that irradiates the rotor 33c of the motor 33 with infrared light and detects the light reflected by the rotor 33c. The sensor 34 detects the reflected light from areas of the rotor 33c where no marker 33d are attached as an ON signal, and detects the reflected light from areas where the marker 33d are attached as an OFF signal because it cannot detect the reflected light. The detection signal detected by the sensor 34 is sent to the controller 29. Note that the method for detecting the rotational phase is not limited thereto. For example, as described in JP2015-155986A, the marker 33d may be disposed on the color wheel disc 32, and the sensor 34 may detect the marker 33d to detect the rotational phase.

The blue light reflected by color wheel disc 32 is incidence on the first main surface 16 of the mirror 15 via the convex lens 18. Here, convex lens 18 is arranged so that the blue light incidence on the color wheel disc 32 and the blue light reflected by the color wheel disc 32 pass through spatially different positions. This allows the blue light reflected by the color wheel 19 to pass through the transmissive portion 31 of the mirror 15 and proceed toward the phosphor wheel 27. Furthermore, if mirror 15 has plural reflective portions 30, each reflective portion 30 is arranged at a position that does not overlap with the blue light reflected by color wheel 19. The plural laser light sources 11 are arranged in accordance with the positions of the reflective portions 30 so that the emitted blue light is reflected by the reflective portions 30.

The convex lens 23 is disposed between the mirror 15 and the phosphor wheel 27, and the convex lens 25 is disposed between the convex lens 23 and the phosphor wheel 27. Here, two convex lenses are disposed due to the relationship between the radius of lens and the radius of curvature, but only one convex lens may be disposed. Blue light passing through the transmissive portion 31 of the mirror 15 is incidence on the subsequent phosphor wheel 27 via a combination of the convex lens 23 and the subsequent convex lens 25. The mirror 15, the convex lens 18, the light receiving position of the color wheel 19, and the light receiving position of the phosphor wheel 27 are all disposed on a straight line, and the blue light reflected by the mirror 15, the blue light reflected by the color wheel 19, and the fluorescent light generated by the phosphor wheel 27 all travel along this straight line. This allows the light source apparatus 3 to be made smaller than conventional light source apparatuses having an optical system that loops blue light.

### 1-2. Configuration of Phosphor Wheel

The phosphor wheel 27 converts incident blue light into light of another color. The phosphor wheel 27 includes a base plate 35, a wavelength conversion element 36 arranged in an annular region on the base plate 35, a motor 38 that rotates the base plate 35 and the wavelength conversion element 36, and a sensor 39 that detects the rotational phase of the motor 38. A detection signal detected by the sensor 39 is sent to the controller 29.

Similar to the motor 33, the motor 38 includes a hub 38a, a stator 38b, and a rotor 38c. The hub 38a is made of metal and is integrally coupled to the base plate 35. A marker 38d for synchronization with the color wheel 19 is disposed at a predetermined location on the peripheral surface of the rotor 38c. The marker 38d is, for example, a black label.

The sensor 39 detects the rotational phase of the motor 38. The sensor 39 is, for example, a reflective optical sensor that irradiates the rotor 38c of the motor 38 with infrared light and detects the light reflected by the rotor 38c. The sensor 39 detects the reflected light from areas of the rotor 38c where no marker 38d are attached as an ON signal, and detects the reflected light from areas where the marker 38d are attached as an OFF signal because it cannot detect the reflected light. The detection signal detected by the sensor 39 is sent to the controller 29. Note that the method for detecting the rotational phase is not limited thereto. For example, similar to the color wheel 19, the marker 38d may be disposed on the base plate 35, and the rotational phase may be detected by the sensor 39 detecting the marker 38d.

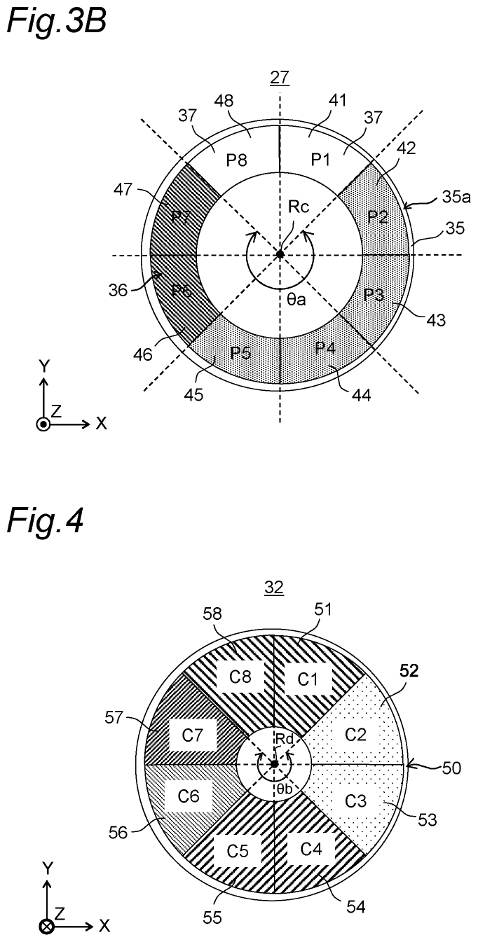

Referring next to FIG. 3A, the arrangement of the phosphor segments of the phosphor wheel 27 will be further described. FIG. 3A is a front view of the phosphor wheel 27. In the following description, for ease of understanding, the phosphor wheel 27 and the color wheel disc 32 will be described as being composed of eight segments with a central angle of 45 degrees. The actual phosphor wheel and the color wheel disc 32 are not limited to being composed of sector-shaped segments with a central angle of 45 degrees.

The base plate 35 is made of, for example, a metal such as aluminum, or a material such as glass or sapphire. A reflective layer (not shown) that reflects visible light is disposed on the base plate 35, and the annular wavelength conversion element 36 is arranged on the reflective layer. A region 37 where no wavelength conversion element is formed is disposed in a part of an annular region 35a where the wavelength conversion element 36 is arranged.

In the annular region 35a, the wavelength conversion element 36 is arranged in segments, and the wavelength conversion characteristics of each segment may be the same or different. The phosphor wheel 27 rotates around its rotation center Rc, and is arranged so that the blue excitation light condensed by the convex lenses 23 and 25 is incidence on the annular wavelength conversion element 36.

The wavelength conversion element 36 has a second segment P2 to a fifth segment P5 that convert the wavelength of incident blue excitation light into a wavelength corresponding to yellow fluorescent light and emits the converted yellow fluorescent light, and a sixth segment P6 and a seventh segment P7 that convert the wavelength of incident blue light into green fluorescent light and emit the converted green fluorescent light. The base plate 35 has a first region 41 to an eighth region 48 obtained by dividing the annular region 35a into the eight regions. A first segment P1 to an eighth segment P8 are respectively arranged in the first region 41 to the eighth region 48 of the base plate 35. The wavelength conversion element 36 is not arranged in the first segment P1 and the eighth segment P8. The wavelength conversion element 36 arranged in the second segment P2 to the fifth segment P5 is, for example, Ce-activated YAG-based yellow phosphors, and a typical chemical structure of the crystalline matrix of the phosphor particles is Y₃Al₅O₁₂. The wavelength conversion element 36 arranged in the sixth segment P6 and the seventh segment P7 is green phosphor, for example, LuAG(Lu₃Al₅O₁₂).

The blue light focused on the wavelength conversion element 36 of the phosphor wheel 27 by the convex lenses 23 and 25 is wavelength-converted to fluorescent light and emitted as completely diffused light, as shown in FIG. 1. The fluorescent light emitted toward the base plate side is changed in direction by 180 degrees by a reflective layer disposed on the base plate 35, and, together with the fluorescent light originally emitted toward the convex lens 25, it again enters the convex lenses 25 and 23 in that order and is collimated. The fluorescent light wavelength-converted from the blue light by the wavelength conversion element 36 is, for example, green light, red light, and yellow light. The yellow light, which serves as the second light having a second wavelength range, has a wavelength component of, for example, 500 nm or greater and 800 nm or less as the yellow wavelength range. The green light, which serves as the third light having a third wavelength range, has a wavelength component of, for example, 500 nm or greater and less than 600 nm as the green wavelength range. The red light, which serves as the fourth light having a fourth wavelength range, has a wavelength component of, for example, 600 nm or greater and 800 nm or less as the red wavelength range. An example in which red light is used as the fluorescent light will be described in a second embodiment.

A part of the blue light focused onto the wavelength conversion element 36 of the phosphor wheel 27 by the convex lenses 23 and 25 is not reflected or wavelength-converted on the surface of the wavelength conversion element, but instead has its direction of travel changed by 180 degrees by a reflective layer arranged on the base plate 35 of the phosphor wheel 27, and is again incidence on the convex lenses 25 and 23 in this order, where it is converted into parallel light.

The green, yellow, and blue light emitted from the convex lens 23 and converted into parallel light are incidence on the mirror 15 again, transmitted through the mirror 15, and then incidence on the convex lens 18. With the above configuration, light in different wavelength regions is time-divided and incidence on the rod integrator 21.

The time-division fluorescent light and blue light incidence on the convex lens 18 from the mirror 15 are condensed by the convex lens 18 and then incidence on the subsequent color wheel disc 32. The color wheel disc 32 is controlled by the controller 29 so as to rotate synchronously with the phosphor wheel 27.

The controller 29 is a circuit that can be implemented using semiconductor elements or the like. The controller 29 can be configured, for example, with a microcomputer, a CPU, an MPU, a GPU, a DSP, an FPGA, or an ASIC. The controller 29 implements predetermined functions by reading data and programs stored in a built-in memory unit (not shown) and performing various arithmetic processing. The memory unit can be implemented, for example, with a hard disc drive (HDD), an SSD, a RAM, a DRAM, a ferroelectric memory, a flash memory, a magnetic disc, or a combination thereof.

In the period during which, for example, yellow fluorescent light is emitted from the phosphor wheel 27, the color wheel 19, which has at least one region selected from among a region that transmits the fluorescent light as it is, a region that reflects a red portion of the fluorescent light and transmits green light, and a region that reflects a green portion of the fluorescent light and transmits red light, is rotated in synchronization. Light reflected by the mirror 15 from the laser light source 11 and guided to the color wheel 19 passes through a portion of the color wheel 19 corresponding to the region that transmits blue light, and colored light of different wavelength ranges is focused in time series near the incident end of the rod integrator 21.

The light incidence on the rod integrator 21 is uniformized within the rod integrator 21, and the uniformized light is emitted from the exit end thereof.

In the above configuration, it is described that there is the region 37 where the wavelength conversion element 36 is not arranged, but the wavelength conversion element may be disposed in a location corresponding to the region 37 due to manufacturing constraints or the like.

### 1-3. Configuration of Color Wheel

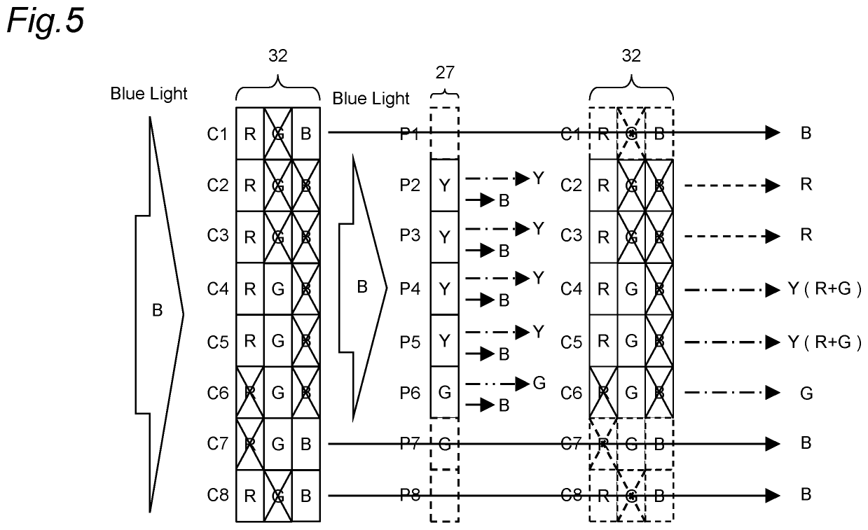

Referring then to FIGS. 4 and 5, the arrangement of filters on the color wheel disc 32 will be further described. FIG. 4 is a rear view of the color wheel disc 32 in a state in which the phosphor wheel and the color wheel are synchronized in a first rotation mode. FIG. 5 is an explanatory diagram illustrating the first rotation mode in which the color wheel and the phosphor wheel rotate synchronously.

The color wheel disc 32 is attached to the hub 33a of the motor 33, and includes a wavelength selection element 50 that selects the wavelength range of light to be transmitted. The wavelength selection element 50 is attached to regions 51 to 58 that are formed by dividing the annular region of the color wheel disc 32 into eight regions.

The wavelength selection element 50 includes, for example, a first segment C1, a second segment C2, a third segment C3, a fourth segment C4, a fifth segment C5, a sixth segment C6, a seventh segment C7, and an eighth segment C8. The first segment C1 to the eighth segment C8 are each formed by a generally sector-shaped glass plate whose surface has been subjected to a predetermined optical treatment, and are respectively assigned to regions 51 to 58 on the color wheel disc 32 and arranged in a ring shape. The generally sector-shaped first segment C1 to the eighth segment C8 are each attached near their centers to the hub 33a of the motor 33 with an adhesive. At the initial rotation angle position of the color wheel 19, the first segment C1 to the eighth segment C8 are arranged in order clockwise. Here, for ease of explanation, each segment is shown as an area with a central angle of 45 degrees, but in practice, the central angle is not limited to 45 degrees.

The first segment C1 and the eighth segment C8 are respectively arranged in regions 51 and 58. The first segment C1 and the eighth segment C8 are coated with a dichroic coating that transmits red and blue light and reflects green light so as not to transmit green light, forming a so-called magenta filter.

The second segment C2 and the third segment C3 are respectively arranged in regions 52 and 53. The second segment C2 and the third segment C3 have thereon a dichroic coating that transmits red light and reflects green and blue light so as to prevent the transmission of green and blue light, forming so-called red filters.

The fourth segment C4 and the fifth segment C5 are arranged in regions 54 and 55. The fourth segment C4 and the fifth segment C5 are coated with a dichroic coating that transmits red and green light and reflects blue light so as to prevent blue light from passing through, forming so-called yellow filters.

The sixth segment C6 is arranged in the region 56. The sixth segment C6 is coated with a dichroic coating that transmits green light and reflects red and blue light so as to prevent red and blue light from passing through, forming a so-called green filter.

The seventh segment C7 is arranged in the region 57. The seventh segment C7 is coated with a dichroic coating that transmits green and blue light and reflects red light so as not to transmit red light, forming a so-called cyan filter.

### 1-4. Rotation Control by Controller

The controller 29 controls the rotational phase positions of the phosphor wheel 27 and the color wheel 19 in one of two rotation modes, the first rotation mode and a second rotation mode, as the rotational phase position of the color wheel 19 relative to the phosphor wheel 27. The first rotation mode in the first embodiment is a mode that emphasizes red in the light emitted from the color wheel 19. The second rotation mode in the first embodiment is a mode that prioritizes the color balance of the light emitted from the color wheel 19.

The first rotation mode will be described with reference to FIG. 5. In the first rotation mode, blue light reflected by the mirror 15 and incidence on the first segment C1, the seventh segment C7, and the eighth segment C8 of the color wheel 19 passes through the color wheel 19 and enters the rod integrator 21 because the segments C1, C7, and C8 each transmit blue light.

The blue light reflected by the mirror 15 and incidence on the second segment C2 to the sixth segment C6 of the color wheel 19 is reflected by the color wheel 19, passes through the mirror 15, and is incidence on the phosphor wheel 27, since each of the second segment C2 to the sixth segment C6 reflects the blue light.

The color wheel 19 and the phosphor wheel 27 rotate synchronously, and the rotational phase positions of the first segment C1 to the eighth segment C8 of the color wheel 19 correspond to the rotational phase positions of the first segment P1 to the eighth segment P8 of the phosphor wheel 27.

The blue light reflected by the second segment C2 and the third segment C3 of the color wheel 19 is incidence on the second segment P2 and the third segment P3 of the phosphor wheel 27, respectively, and converted into yellow light. The converted yellow light and the unconverted blue light are incidence on the second segment C2 and the third segment C3 of the color wheel 19, and only the red light component contained in the yellow light passes through the second segment C2 and the third segment C3, to become red light and enter the rod integrator 21.

The blue light reflected by the fourth segment C4 and the fifth segment C5 of the color wheel 19 is incidence on the fourth segment P4 and the fifth segment P5 of the phosphor wheel 27, respectively, and converted into yellow light. The converted yellow light and the unconverted blue light are incidence on the fourth segment C4 and the fifth segment C5 of the color wheel 19, and only the red light and green light components contained in the yellow light pass through the fourth segment C4 and the fifth segment C5, and the yellow light is incidence on the rod integrator 21 as is.

The blue light reflected by the sixth segment C6 of the color wheel 19 is incidence on the sixth segment P6 of the phosphor wheel 27 and converted into green light. The converted green light and the unconverted blue light are incidence on the sixth segment C6 of the color wheel 19, and only the green light passes through the sixth segment C6 as is and enters the rod integrator 21.

In the first rotation mode, the yellow light emitted from the color wheel 19 to the rod integrator 21 is considered to contain red and green light components in a 1:1 ratio, so the ratio of colored light incidence on the rod integrator 21 is red light:green light:blue light=4:3:3. Hence, in the first rotation mode, a color enhancer that emphasizes red can be implemented. As described above, the yellow and green light converted by the phosphor wheel 27 also contains a small amount of reflected blue light without being converted. However, since the converted yellow and green light pass through segments of the color wheel 19 that do not allow blue light to pass through, the blue light is cut off. Therefore, the red and green light incidence on the rod integrator 21 is not mixed with blue light, so vivid red and green light can be implemented, and the range of reproducible colors can be expanded.

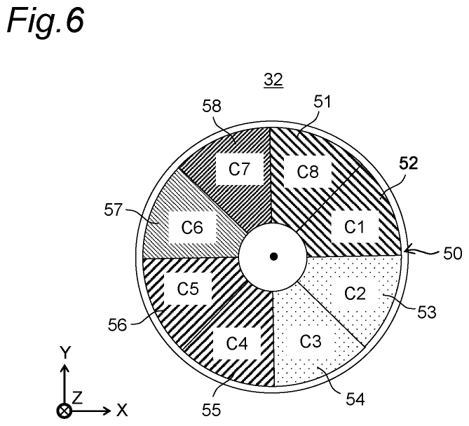

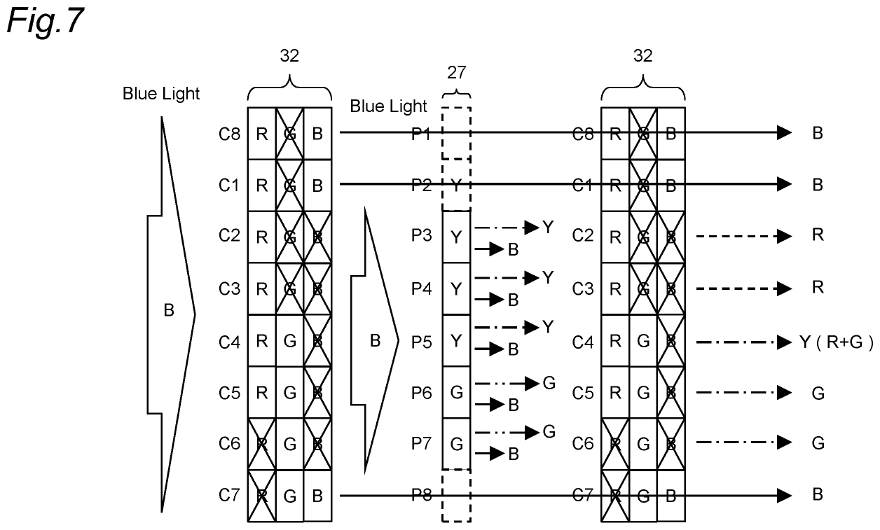

Referring next to FIGS. 6 and 7, the second rotation mode will be described. FIG. 6 is a rear view of the color wheel disc 32 at the initial position in the second rotation mode. FIG. 7 is an explanatory diagram illustrating the second rotation mode in which the color wheel 19 and the phosphor wheel 27 rotate synchronously.

In the second rotation mode, the color wheel disc 32 is rotated 45 degrees clockwise relative to the phosphor wheel from the initial position in the first rotation mode, and the phosphor wheel 27 is synchronized with the color wheel 19. Therefore, the rotational phase positions of the first segment C1 to the seventh segment C7 of the color wheel 19 correspond to those of the second segment P2 to the eighth segment P8 of the phosphor wheel 27, and the rotational phase positions of the eighth segment C8 of the color wheel 19 correspond to those of the first segment P1 of the phosphor wheel 27, and the color wheel 19 and the phosphor wheel 27 rotate synchronously.

In the second rotation mode, blue light reflected by the mirror 15 and incidence on the eighth segment C8, the first segment C1, and the seventh segment C7 of the color wheel 19 passes through the color wheel 19 and enters the rod integrator 21 because each of the segments C8, C1, and C7 transmits blue light.

The blue light reflected by the mirror 15 and incidence on the second segment C2 to the sixth segment C6 of the color wheel 19 is reflected by the color wheel 19, passes through the mirror 15, and is incidence on the phosphor wheel 27, since each of the second segment C2 to the sixth segment C6 reflects the blue light.

The blue light reflected by the second segment C2 and the third segment C3 of the color wheel 19 is incidence on the third segment P3 and the fourth segment P4 of the phosphor wheel 27, respectively, and is converted into yellow light. The converted yellow light and the unconverted blue light are incidence on the second segment C2 and the third segment C3 of the color wheel 19, and only the red light component contained in the yellow light passes through the second segment C2 and the third segment C3, to become red light and enter the rod integrator 21.

The blue light reflected by the fourth segment C4 of the color wheel 19 is incidence on the fifth segment P5 of the phosphor wheel 27 and converted into yellow light. The converted yellow light and the unconverted blue light are incidence on the fourth segment C4 of the color wheel 19, and only the red and green light components contained in the yellow light pass through the fourth segment C4, and the yellow light is incidence on the rod integrator 21 as is.

The blue light reflected by the fifth segment C5 and the sixth segment C6 of the color wheel 19 is incidence on the sixth segment P6 and the seventh segment P7 of the phosphor wheel 27, respectively, and converted into green light. The converted green light and the unconverted blue light are incidence on the fifth segment C5 and the sixth segment C6 of the color wheel 19, and only the green light passes through the fifth segment C5 and the sixth segment C6 as is and is incidence on the rod integrator 21.

In the second rotation mode, the yellow light emitted from the color wheel 19 to the rod integrator 21 is considered to contain red and green light components in a 1:1 ratio, so the ratio of colored light incidence on the rod integrator 21 is red light:green light:blue light=3:3:3. In the first rotation mode, as described above, the ratio of red light:green light:blue light=4:3:3, and it can be seen that the red ratio is lower. In practice, the central angles of each region may not be the same 45 degrees, but the above explanation can be used to explain the increase or decrease in the red ratio. Also, as described above, in the second rotation mode, the yellow and green light converted by the phosphor wheel 27 also contains a small amount of blue light that is reflected without being converted. However, since the converted yellow and green light passes through segments of the color wheel 19 that do not allow blue light to pass through, the blue light is cut off. Therefore, the red and green light incidence on the rod integrator 21 is not mixed with blue light, so vivid red and green light can be achieved, and the range of reproducible colors can be expanded.

In this way, in order to implement the rotational phase position control of the color wheel 19 relative to the phosphor wheel 27 in two rotation modes, it is necessary to ensure the amount of phase shift, and it is necessary to satisfy Formula (1) below.

In FIG. 3B, the sum of the central angles around the rotation center Rc of the segments of the phosphor wheel 27 where the wavelength conversion element 36 is arranged is θa. In FIG. 4, the sum of the central angles of the segments that reflect the excitation light (blue light) with respect to the rotation center Rd is θb.

$$θ a \geq θ b \qquad Formula ( 1 )$$

must be satisfied.

By arranging the segments of the phosphor wheel 27 and the color wheel 19 so as to satisfy the condition of Formula (1), it is possible to prevent the blue light from mixing and to emit light of different color modes from the light source apparatus 3 in two modes.

### 1-5. Effects, Etc.

As described above, in the first embodiment, the light source apparatus 3 includes the laser light source 11 that emits blue light as a first light having a first wavelength range, the mirror 15 that is disposed at a position where blue light is incident and has the reflective portion 30 that reflects blue light and the transmissive portion 31 that transmits blue light, and transmits yellow light, green light, and red light that are second light having a second wavelength range different from the first wavelength range, the convex lens 18 that is disposed at a position where it receives the blue light reflected by the mirror 15, the color wheel 19 that transmits or reflects the blue light collected by the convex lens 18 depending on its rotation state, and the phosphor wheel 27 that has the second segment P2 to the seventh segment P7 that wavelength-converts the blue light reflected by the color wheel 19 into yellow light, green light, or red light. The blue light incidence on the color wheel 19 and the blue light reflected by the color wheel 19 pass through spatially different positions on the convex lens 18.

Since the blue light incidence on the color wheel 19 and the blue light reflected by the color wheel 19 pass through spatially different positions in the convex lens 18, it is possible to prevent the blue light reflected by the color wheel 19 from returning to the laser light source 11 and to reduce light loss. Furthermore, because polarized light is not used to separate the blue light into the blue light emitted from the light source apparatus and the blue light for conversion into yellow light and green light, no light loss due to rotation of polarized light in optical elements occurs. Therefore, light loss can be further reduced compared to separation of blue light by polarization.

Since two types of color modes can be selected depending on the rotation mode of the phosphor wheel 27 and the color wheel 19, and furthermore, since there is no mixing of blue light with red and green light, it is possible to improve the chromaticity of the light emitted from the light source apparatus 3. Furthermore, since there is no need for a looping optical path for the blue light, it is possible to achieve a reduction in size of the light source apparatus 3.

The color wheel 19 also has the first segment C1, the seventh segment C7, and the eighth segment C8 as transmission segments that transmit the blue light focused by the convex lens 18, and the second segment C2 to the sixth segment C6 as reflection segments that reflect the blue light focused by the convex lens 18. The light source apparatus 3 includes the motor 33 that rotates the color wheel 19, the motor 38 that rotates the phosphor wheel 27, and the controller 29 that controls at least one of the color wheel 19 and the phosphor wheel 27 to change the rotational phase.

The controller 29 controls the driving of the motor 33 and the rotation of the motor 33 so as to change the rotational phase of at least one of the color wheel 19 and the phosphor wheel 27, so that light of different color modes can be emitted from the light source apparatus 3.

Furthermore, the controller 29 controls the rotational phase positions of the phosphor wheel 27 and the color wheel 19 in either the first rotation mode or the second rotation mode as the rotational phase position of the color wheel 19 relative to the phosphor wheel 27. This allows light of two different color modes to be emitted from the light source apparatus 3.

Furthermore, the sum θb of the angles of the second segment C2 to the sixth segment C6, which act as reflection segments that reflect blue light in the color wheel 19, relative to the center of rotation Rd is equal to or less than the sum θa of the angles of the second segment P2 to the seventh segment P7, which act as wavelength conversion segments in the phosphor wheel 27, relative to the rotation center Rc. This enables proper phase shifting and prevents blue light from mixing with the red and green light emitted from the light source apparatus 3.

### Second Embodiment

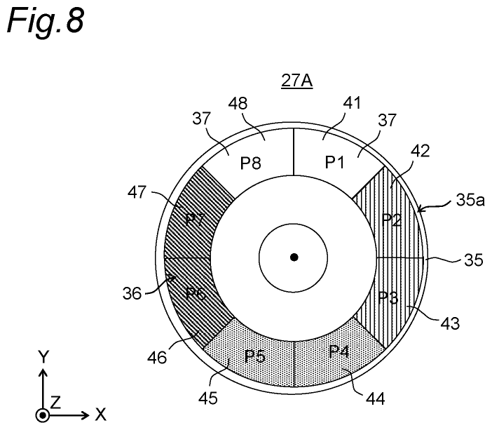

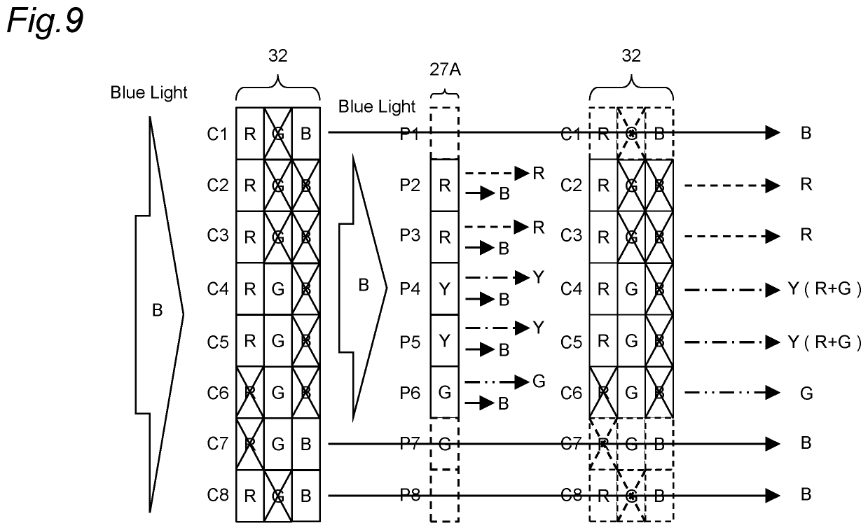

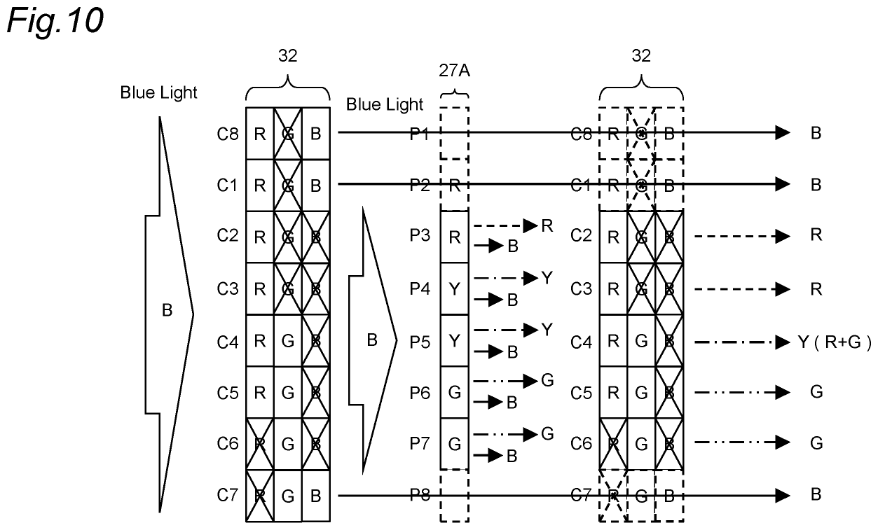

The light source apparatus 3 of the second embodiment will be described with reference to FIGS. 8 to 10. FIG. 8 is a front view of a phosphor wheel 27A according to the second embodiment. FIG. 9 is an explanatory diagram illustrating a first rotation mode in which the color wheel 19 and the phosphor wheel 27A according to the second embodiment rotate synchronously. FIG. 10 is an explanatory diagram illustrating a second rotation mode in which the color wheel and the phosphor wheel according to the second embodiment rotate synchronously.

The phosphor wheel 27A in the second embodiment differs from the phosphor wheel 27 in the first embodiment in the filters of the second segment P2 and the third segment P3. Except for this point and points described below, the light source apparatus in the second embodiment and the light source apparatus in the first embodiment have the same configuration.

As shown in FIG. 8, in the phosphor wheel 27A of the second embodiment, the second segment P2 and the third segment P3 convert the wavelength of incident blue excitation light into red fluorescent light and emit the red fluorescent light. The wavelength conversion element 36 arranged in the second segment P2 and the third segment P3 is red phosphor, such as α-sialon phosphor (Si₁₂₋₍ₘ₊ₙ₎AL₍ₘ₊ₙ₎OₙN₁₆₋ₙ).

Next, the first rotation mode in the second embodiment will be described with reference to FIG. 9. In the first rotation mode, the blue light reflected by the mirror 15 and incidence on the first segment C1, the seventh segment C7, and the eighth segment C8 of the color wheel 19 passes through the color wheel 19 and enters the rod integrator 21, as in the first embodiment.

The blue light reflected by the mirror 15 and incidence on the second segment C2 to the sixth segment C6 of the color wheel 19 is reflected by the color wheel 19, passes through the mirror 15, and incidence on the phosphor wheel 27A, as in the first embodiment.

The color wheel 19 and the phosphor wheel 27A rotate in synchronization, and the first segment C1 to the eighth segment C8 of the color wheel 19 correspond in rotational phase position to the first segment P1 to the eighth segment P8 of the phosphor wheel 27A.

The blue light reflected by the second segment C2 and the third segment C3 of the color wheel 19 is incidence on the second segment P2 and the third segment P3 of the phosphor wheel 27A, respectively, and is converted to red. The converted red light and the unconverted blue light are incidence on the second segment C2 and the third segment C3 of the color wheel 19, and only the red light passes through the second segment C2 and the third segment C3, and is incidence on the rod integrator 21.

The blue light reflected by the fourth segment C4 and the fifth segment C5 of the color wheel 19 is incidence on the fourth segment P4 and the fifth segment P5 of the phosphor wheel 27A, respectively, and converted into yellow light. The converted yellow light and the unconverted blue light are incidence on the fourth segment C4 and the fifth segment C5 of the color wheel 19, and only the red light and green light components contained in the yellow light pass through the fourth segment C4 and the fifth segment C5, and the yellow light (red light+green light) is incidence on the rod integrator 21 as is.

The blue light reflected by the sixth segment C6 of the color wheel 19 is incidence on the sixth segment P6 of the phosphor wheel 27A and converted into green light. The converted green light and the unconverted blue light are incidence on the sixth segment C6 of the color wheel 19, and only the green light passes through the sixth segment C6 as is and enters the rod integrator 21.

In the first rotation mode, the ratio of color light incidence on the rod integrator 21 is red light:green light:blue light=4:3:3. Therefore, in the first rotation mode, a color enhancer that emphasizes red can be implemented. As described above, the red light and green light incidence on the rod integrator 21 are not mixed with blue light, so vivid red light and green light can be implemented, and the range of reproducible colors can be expanded.

Next, the second rotation mode will be described with reference to FIG. 10. In the second rotation mode, as in the first embodiment, the color wheel disc 32 is rotated 45 degrees clockwise relative to the phosphor wheel 27 from the synchronization position in the first rotation mode, which is the synchronization position. Therefore, the rotational phase positions of the first segment C1 to the seventh segment C7 of the color wheel 19 correspond to the rotational phase positions of the second segment P2 to the eighth segment P8 of the phosphor wheel 27A, and the rotational phase positions of the eighth segment C8 of the color wheel 19 correspond to the rotational phase positions of the first segment P1 of the phosphor wheel 27A, and the color wheel 19 and the phosphor wheel 27A rotate synchronously.

In the second rotation mode, the blue light reflected by the mirror 15 and incidence on the eighth segment C8, the first segment C1, and the seventh segment C7 of the color wheel 19 passes through the color wheel 19 and enters the rod integrator 21, as in the first embodiment.

The blue light reflected by the mirror 15 and incidence on the second segment C2 to the sixth segment C6 of the color wheel 19 is reflected by the color wheel 19, passes through the mirror 15, and incidence on the phosphor wheel 27A, as in the first embodiment.

The blue light reflected by the second segment C2 of the color wheel 19 is incidence on the third segment P3 of the phosphor wheel 27 and converted into red light. The converted red light and the unconverted blue light are incidence on the second segment C2 of the color wheel 19, and the red light passes through the second segment C2 as is and enters the rod integrator 21.

The blue light reflected by the third segment C3 of the color wheel 19 enters the fourth segment P4 of the phosphor wheel 27 and is converted into yellow light. The converted yellow light and the unconverted blue light enter the second segment C2 of the color wheel 19, and only the red light component contained in the yellow light passes through the second segment C2 to become red light and enter the rod integrator 21.

The blue light reflected by the fourth segment C4 of the color wheel 19 is incidence on the fifth segment P5 of the phosphor wheel 27 and converted into yellow light. The converted yellow light is incidence on the fourth segment C4 of the color wheel 19, and the red and green light components contained in the yellow light pass through the fourth segment C4, and the yellow light enters the rod integrator 21 as is.

The blue light reflected by the fifth segment C5 and the sixth segment C6 of the color wheel 19 is incidence on the sixth segment P6 and the seventh segment P7 of the phosphor wheel 27, respectively, and is converted into green light. The converted green light and the unconverted blue light are incidence on the fifth segment C5 and the sixth segment C6 of the color wheel 19, and only the green light passes through the fifth segment C5 and the sixth segment C6, and enters the rod integrator 21.

In the second rotation mode, the yellow light emitted from the color wheel 19 to the rod integrator 21 is considered to contain red and green light components in a 1:1 ratio, so the ratio of colored light incidence on the rod integrator 21 is red light:green light:blue light=3:3:3. Therefore, in the second rotation mode, the red ratio can be reduced compared to the first rotation mode, and the balance of the colored light emitted by the light source apparatus 3 can be equalized. As described above, even in the second rotation mode, the yellow and green light converted by the phosphor wheel 27 contains a small amount of blue light that is reflected without being converted. However, the converted yellow and green light passes through a segment of the color wheel 19 that does not allow blue light to pass through, so the blue light is cut off. Therefore, the red, green, and yellow light incidence on the rod integrator 21 are not mixed with blue light, so vivid red and green light can be implemented, and the range of reproducible colors can be expanded.

### Third Embodiment

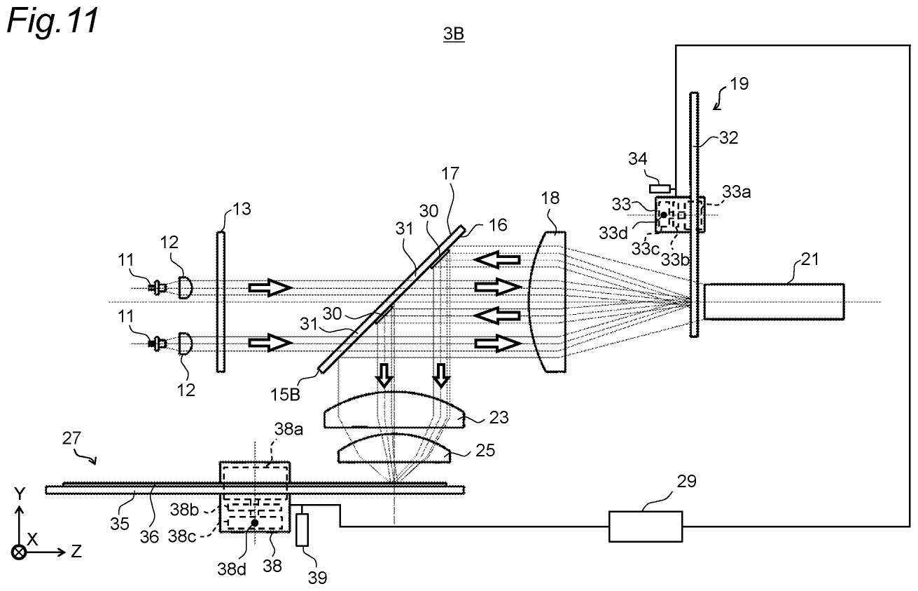

A light source apparatus 3B according to a third embodiment will be described with reference to FIG. 11. FIG. 11 is an overall view showing the configuration of the light source apparatus 3B according to the third embodiment.

In the light source apparatus 3 of the first embodiment, blue light emitted from the laser light source 11 is reflected by the mirror 15 and enters the color wheel 19. In the light source apparatus 3B of the third embodiment, blue light emitted from the laser light source 11 is transmitted by a mirror 15B and enters the color wheel 19. Furthermore, the blue light reflected by the color wheel 19 is reflected by the mirror 15B and enters the phosphor wheel 27. Except for this point and the points described below, the light source apparatus 3B of the third embodiment and the light source apparatus 3 of the first embodiment have common configurations.

In the light source apparatus 3B of the third embodiment, blue light emitted from the laser light source 11 passes through the collimator lens 12 and the diffuser plate 13, enters the second main surface 17 of the mirror 15B, passes through the transmissive portion 31 of the mirror 15B, and enters the convex lens 18. The blue light incidence on the convex lens 18 enters the color wheel 19 in the same manner as in first embodiment, and when it enters a segment of the color wheel 19 that transmits blue light, it passes through the color wheel 19 and enters the rod integrator 21.

When blue light is incidence on a segment of the color wheel 19 that reflects blue light, it is reflected by the color wheel 19. The blue light reflected by the color wheel 19 passes through a spatially different position in the convex lens 18 from the blue light that is incidence on the color wheel 19. As a result, the blue light reflected by the color wheel 19 passes through the convex lens 18, then enters the reflective portion 30 arranged on the first main surface 16 of the mirror 15B and is reflected toward the phosphor wheel 27. The blue light reflected by the reflective portion 30 of the mirror 15B passes through the convex lenses 23 and 25 and enters each segment of the phosphor wheel 27. Depending on the segment into which it is incident, the blue light is converted into color light of a different wavelength range, and the converted color light passes through the convex lenses 25 and 23 and enters the first main surface 16 of the mirror 15B.

Since the first main surface 16 of the mirror 15B has thereon a dichroic coating that reflects light in the yellow wavelength range, it can reflect incident red light, green light, and yellow light. The colored light converted by the phosphor wheel 27 is reflected by the first main surface 16 of the mirror 15B, passes through the convex lens 18, and enters the color wheel 19, as in the first embodiment.

Even with this configuration, as in the first embodiment, by controlling the rotational phase positions of the phosphor wheel 27 and the color wheel 19 in the first rotation mode and the second rotation mode, it is possible to implement the two types of color modes shown in FIGS. 5 and 7, or the two types of color modes shown in FIGS. 9 and 10.

As described above, in the third embodiment, the light source apparatus 3B includes: the laser light source 11 that emits blue light as the first light having the first wavelength range; the mirror 15 disposed at a position where blue light is incident and having the reflective portion 30 that reflects blue light and the transmissive portion 31 that transmits blue light, the mirror 15 reflecting yellow light, red light, and green light that are the second light having the second wavelength range different from the first wavelength range; the convex lens 18 disposed at a position where it receives the blue light transmitted through the mirror 15; the color wheel 19 that transmits or reflects the blue light collected by the convex lens 18 depending on its rotation state; and the phosphor wheel 27 having the second segment P2 to the seventh segment P7 that wavelength-converts the blue light reflected by the color wheel 19 into yellow light, red light, or green light. The blue light incidence on the color wheel 19 and the blue light reflected by the color wheel 19 pass through spatially different positions on the convex lens 18.

Similar to the first embodiment, the blue light incidence on the color wheel 19 and the blue light reflected by the color wheel 19 pass through spatially different positions on the convex lens 18, thereby preventing the blue light reflected by the color wheel 19 from returning to the laser light source 11 and reducing light loss. Furthermore, because no polarization effect is used, light loss can be further reduced, and no mixing of blue light into red and green light occurs, thereby making it possible to improve the chromaticity of the light emitted from the light source apparatus 3B.

### Fourth Embodiment

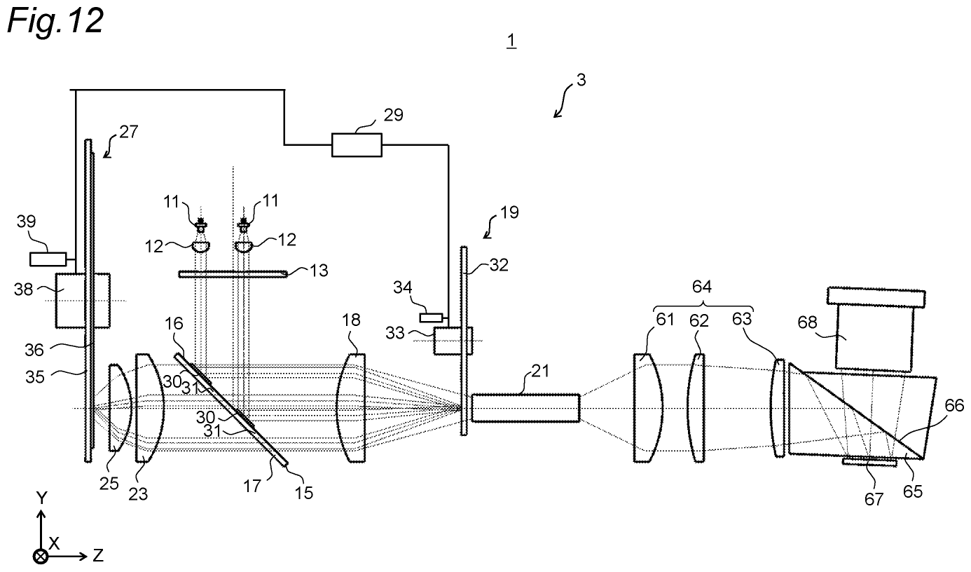

A projection-type image display apparatus 1 according to a fourth embodiment will be described with reference to FIG. 12. FIG. 12 is an overall view showing the configuration of the projection-type image display apparatus 1 according to the fourth embodiment.

The projection-type image display apparatus 1 of the fourth embodiment is, for example, a so-called one-chip DMD projector that uses one DMD, as shown in FIG. 12. The projection-type image display apparatus 1 shown in FIG. 12 includes the light source apparatus 3 of the first embodiment, but may also include the light source apparatus of the second embodiment or the light source apparatus 3B of the third embodiment.

The light emitted from the rod integrator 21 of the light source apparatus 3 is mapped onto a DMD 67 (described later) by a relay lens system 64 made up of convex lenses 61, 62, and 63.

Light passing through the convex lenses 61, 62, and 63 and incidence on a total reflection prism 65 enters a micro gap 66 of the total reflection prism 65 at an angle equal to or greater than the total reflection angle and is reflected to change the direction of travel of the light and enter the DMD 67.

The DMD 67 changes the direction of the micromirror to change the direction of travel of light for emitting the light, in response to a signal from an image circuit (not shown) synchronized with the colored light emitted by the combination of the phosphor wheel 27 and the color wheel 19.

The light whose direction of travel has been changed in response to the image signal by the DMD 67 is incidence on the total reflection prism 65 and enters the micro gap 66 of the total reflection prism 65 at an angle equal to or less than the total reflection angle, thereby passing through as is and entering a projection lens unit 68, where it is projected onto a screen not shown.

According to the projection type image display apparatus 1 of the fourth embodiment, since it includes the light source apparatus 3, it is possible to reduce light loss, to select from a plurality of color modes, and further to improve the chromaticity of the projected image light.

### Fifth Embodiment

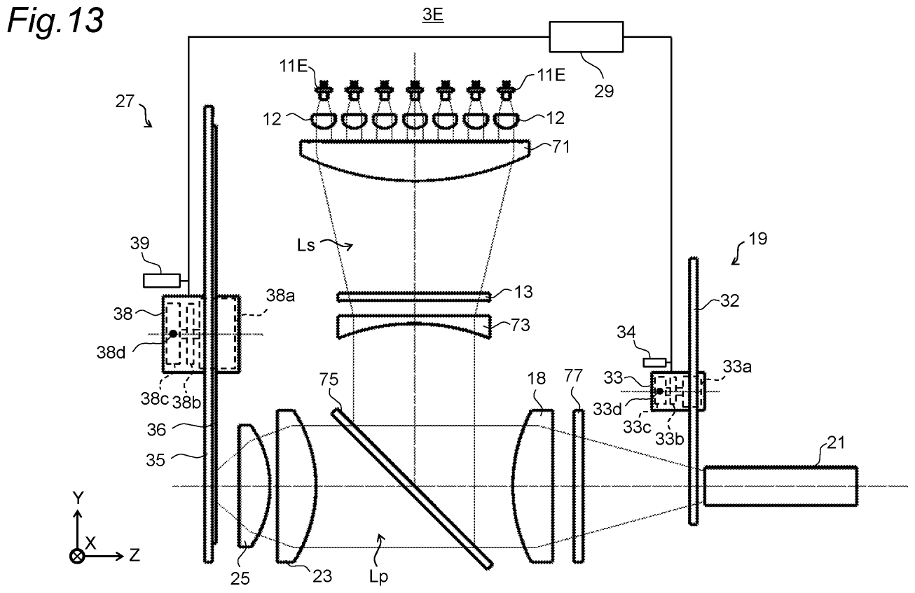

A light source apparatus 3E according to a fifth embodiment will be described with reference to FIG. 13. FIG. 13 is an overall view showing the configuration of the light source apparatus 3E according to the fifth embodiment.

In the light source apparatus 3 of the first embodiment, the blue light transmitted through the mirror 15 and the blue light reflected by the mirror 15 are separated into their respective optical paths, thereby preventing the blue light from returning to the laser light source 11. In the light source apparatus 3E of the fifth embodiment, the polarization state of the blue light emitted from a laser light source 11E is changed, thereby preventing the blue light from returning to the laser light source 11E. Except for this point and other points described below, the light source apparatus 3E of the fifth embodiment and the light source apparatus 3 of the first embodiment have common configurations.

The light source apparatus 3E of the fifth embodiment includes the laser light source 11E, a wavelength-selective polarization separation element 75, the convex lens 18, the color wheel 19, the rod integrator 21, the convex lenses 23 and 25, the phosphor wheel 27, and the controller 29. The light source apparatus 3E further includes the collimator lens 12, the diffuser plate 13, a convex lens 71, a concave lens 73, and a quarter-wave plate 77.

Blue light in the blue wavelength range emitted from the plurality of laser light sources 11E is collimated by a plurality of collimator lenses 12 disposed corresponding to each of the laser light sources 11E. The collimated blue light enters the subsequent convex lens 71, where its beam width is reduced, and then enters the subsequent diffuser plate 13 where it is diffused and the uniformity of the light is improved. The blue light with the improved uniformity of the light enters the subsequent concave lens 73 and is converted into a parallel beam.

The wavelength-selective polarization separation element 75 transmits the P-polarized component of the incident blue light and reflects the S-polarized component. The wavelength-selective polarization separation element 75 is, for example, a wavelength-selective polarizing beam splitter. Since the blue light Ls is emitted from the laser light source 11E as an S wave having an S-polarized component, the blue light Ls incidence on the wavelength-selective polarization separation element 75 is reflected by the wavelength-selective polarization separation element 75 and enters the convex lens 18. The blue light Ls incidence on the convex lens 18 is transmitted through the quarter-wave plate 77 while being condensed.

The quarter-wave plate 77 is disposed between the convex lens 18 and the color wheel 19, and converts linearly polarized light into circularly polarized light and vice versa. The blue light passing through the quarter-wave plate 77 becomes circularly polarized light and enters the color wheel 19.

When the circularly polarized blue light incidence on the color wheel 19 impinges on a segment of the color wheel 19 that transmits blue light, it is transmitted through the color wheel 19 and enters the rod integrator 21.

When the circularly polarized blue light incidence on the color wheel 19 strikes a segment of the color wheel 19 that reflects blue light, it is reflected by the color wheel 19. The circularly polarized blue light reflected by the color wheel 19 is transmitted through the quarter-wave plate 77 again, changing from circularly polarized light to blue light Lp as a P wave having a P-polarized component, and then is transmitted through the convex lens 18.

The blue light Lp transmitted through the convex lens 18 is transmitted through the wavelength-selective polarization separation element 75 and passes through the convex lenses 23 and 25 to impinge on each segment of the phosphor wheel 27. The blue light is converted into colored light of a different wavelength range depending on the segment on which it impinges. The converted colored light passes through the convex lenses 25 and 23 to be transmitted through the wavelength-selective polarization separation element 75.

The colored light transmitted through the wavelength-selective polarization separation element 75 passes through the convex lens 18 and the quarter-wave plate 77 and enters the color wheel 19 in the same manner as in the first embodiment.

Even with this configuration, as in the first embodiment, by controlling the rotational phase positions of the phosphor wheel 27 and the color wheel 19 in the first rotation mode and the second rotation mode, it is possible to implement the two types of color modes shown in FIGS. 5 and 7 or the two types of color modes shown in FIGS. 9 and 10. Furthermore, although the effect is less than that of the first embodiment, it is possible to reduce light loss and prevent mixing of red light, green light, and yellow light with blue light, thereby achieving an improvement in the chromaticity of the light emitted from the light source apparatus 3.

### Other Embodiments

(1) In each of the above embodiments, the phosphor wheel 27 is used as the wavelength conversion element, but this is not limitative. A wheel having a wavelength conversion element using quantum dots instead of phosphor may also be used.
(2) In each of the above embodiments, the controller 29 controls two rotational phase patterns, but this is not limitative. The controller 29 may control three or more rotational phase patterns to implement three or more color modes of light emitted from the light source unit.

As described above, the above embodiments have been described as examples of the technology disclosed in the present application. However, the technology in the present disclosure is not limited thereto, and can be applied to embodiments in which modifications, permutations, additions, omissions, etc. are made. Furthermore, it is also possible to combine the components described in the above embodiments to create new embodiments.

As described above, the embodiments have been described as examples of the technology of the present disclosure. For this purpose, the accompanying drawings and detailed description have been provided. Accordingly, the components described in the accompanying drawings and detailed description may include not only components essential for solving the problem, but also components that are not essential for solving the problem in order to exemplify the above technology. Therefore, the mere fact that these non-essential components are described in the accompanying drawings or detailed description should not immediately be construed as indicating that these non-essential components are essential.

### Overview of the Embodiments

(1) A light source apparatus of the present disclosure comprises: a light source that emits a first light having a first wavelength range; a first wavelength selection element disposed at a position where the first light is incident and having a reflective portion that reflects the first light and a transmissive portion that transmits the first light, the first wavelength selection element transmitting a second light having a second wavelength range different from the first wavelength range; a light-collecting element disposed at a position to receive the first light reflected by the first wavelength selection element; a second wavelength selection element that transmits or reflects, depending on its rotation state, the first light collected by the light-collecting element; and a wavelength conversion element having a wavelength conversion segment that wavelength-converts the first light reflected by the second wavelength selection element into the second light. The first light incidence on the second wavelength selection element and the first light reflected by the second wavelength selection element pass through spatially different positions in the light-collecting element.
(2) A light source apparatus of the present disclosure comprises: a light source that emits a first light having a first wavelength range; a first wavelength selection element disposed at a position where the first light is incident and having a reflective portion that reflects the first light and a transmissive portion that transmits the first light, the first wavelength selection element reflecting a second light having a second wavelength range different from the first wavelength range; a light-collecting element disposed at a position to receive light transmitted through the first wavelength selection element; a second wavelength selection element that transmits or reflects, depending on its rotation state, light collected by the light-collecting element; and a wavelength conversion element having a wavelength conversion segment that wavelength-converts the first light reflected by the second wavelength selection element into the second light. The first light incidence on the second wavelength selection element and the first light reflected by the second wavelength selection element pass through spatially different positions in the light-collecting element.

According to the configuration of (1) or (2), the first light incidence on the second wavelength selection element and the first light reflected by the second wavelength selection element pass through spatially different positions in the condensing element, whereby it is possible to prevent the first light reflected by the second wavelength selection element from returning to the light source and to reduce light loss. Furthermore, since the first light can be emitted from the second wavelength selection element or reflected by the second wavelength selection element and converted into a wavelength by the wavelength conversion element without using a loop configuration, the light source apparatus can be made smaller than before.
(3) In the light source apparatus of (1) or (2), the second wavelength selection element includes: a transmission segment that transmits the first light collected by the light-collecting element; and a reflection segment that reflects the first light collected by the light-collecting element. The light source apparatus comprises: a first rotation drive that rotates the wavelength selection element; a second rotation drive that rotates the wavelength conversion element; and a controller that controls at least one of the second wavelength selection element and the wavelength conversion element so as to change the rotational phase.
(4) In the light source apparatus of (3), the controller controls the rotational phase positions of the wavelength conversion element and the second wavelength selection element in one of at least two rotation modes as a rotational phase position of the second wavelength selection element relative to the wavelength conversion element.
(5) In the light source apparatus of (3) or (4), the sum of angles of the reflection segments that reflect the first light around a rotation center of the second wavelength selection element is equal to or less than the sum of angles of the wavelength conversion segments around a rotation center of the wavelength conversion element.
(6) In the light source apparatus of any one of (1) to (5), in the first wavelength selection element, the reflective portions are arranged in a band shape.
(7) In the light source apparatus of any one of (1) to (6), the second light includes, in a time-divided manner, light in at least two different wavelength ranges included in the second wavelength range. The wavelength conversion element is excited by the first light and emits fluorescent light in at least two different wavelength ranges.
(8) In the light source apparatus of (7), the first light is blue laser light; the second light includes a third light having a third wavelength range included in the second wavelength range; the wavelength conversion element includes a first phosphor segment that is excited by the first light and emits the second light as fluorescent light and a second phosphor segment that is excited by the first light and emits the third light as fluorescent light; and the first phosphor segment is a yellow phosphor segment that emits yellow fluorescent light as the second light, while the second phosphor segment is a green phosphor segment that emits green fluorescent light as the third light.
(9) In the light source apparatus of (8), the second wavelength selection element includes a segment that transmits the yellow second light as red light when the yellow second light is incident thereon.
(10) A projection-type image display apparatus of the present disclosure comprises a color wheel unit of any one of (1) to (9).
(11) A light source apparatus of the present disclosure comprises: a light source that emits a first light having a first linearly polarized component and having a first wavelength range; a polarization separation element that is disposed at a position where the first light is incident and that reflects the first light having the first linearly polarized component and transmits a second light having a second linearly polarized component orthogonal to the first linearly polarized component and having the first wavelength range; a polarization conversion element that is disposed at a position where the first light reflected by the polarization separation element is received and that converts linearly polarized light into circularly polarized light and converts circularly polarized light into linearly polarized light; a second wavelength selection element that transmits or reflects, depending on its rotational state, the first light converted into circularly polarized light by a polarization element; and a wavelength conversion element including a wavelength conversion segment that wavelength-converts into a third light the second light obtained by subjecting the first light reflected by the second wavelength selection element to polarization conversion by the polarization conversion element and transmitted through the polarization separation element. The second wavelength selection element includes a transmission segment that transmits the second light collected by the light-collecting element and a reflection segment that reflects the second light collected by the light-collecting element. The light source apparatus comprises: a first rotation drive that rotates the wavelength selection element; a second rotation drive that rotates the wavelength conversion element; and a controller that controls at least one of the second wavelength selection element and the wavelength conversion element so as to change the rotational phase.

Since the polarization state differs between the first light incidence on the polarization separation element from the light source and the second light incidence on the polarization separation element from the second wavelength selection element, it is possible to prevent the second light reflected by the second wavelength selection element from returning to the light source, thereby reducing light loss. Furthermore, without using a loop configuration, it is possible to emit the first light from the second wavelength selection element, or to reflect the first light on the second wavelength selection element and then wavelength-convert it into the third light by the wavelength conversion element, thereby enabling the light source apparatus to be made more compact than before.

The present disclosure is applicable to a light source apparatus that uses light whose wavelength has been converted by a phosphor wheel, and to a projection-type image display apparatus that includes the light source apparatus.

### EXPLANATIONS OF LETTERS OR NUMERALS

1 projection-type image display apparatus
3, 3B, 3E light source apparatus
11, 11E laser light source
12 collimator lens
13 diffuser plate
15, 15B, 15E mirror
16 first main surface
17 second main surface
18 convex lens
19 color wheel
21 rod integrator
23, 25 convex lens
27 phosphor wheel
29 controller
30 reflective portion
31 transmissive portion
32 color wheel disc
33 motor
33a hub
33b stator
33c rotor
33d marker
34 sensor
35 base plate
35a annular region
36 wavelength conversion element
37 region
38 motor
38a hub
38b stator
38c rotor
38d marker
41 first region
42 second region
43 third region
44 fourth region
45 fifth region
46 sixth region
47 seventh region
48 eighth region
50 wavelength selection element
51 first region
52 second region
53 third region
54 fourth region
55 fifth region
56 sixth region
57 seventh region
58 eighth region
61, 62, 63 convex lens
64 relay lens system
65 total reflection prism
66 micro gap
67 DMD
68 projection lens unit
71 convex lens
73 concave lens
75 wavelength-selective polarization separation element
77 quarter-wave plate
C1 first segment
C2 second segment
C3 third segment
C4 fourth segment
C5 fifth segment
C6 sixth segment
C7 seventh segment
C8 eighth segment
P1 first segment
P2 second segment
P3 third segment
P4 fourth segment
P5 fifth segment
P6 sixth segment
P7 seventh segment
P8 eighth segment

What is claimed is

1. A light source apparatus comprising:
a light source that emits a first light having a first wavelength range;
a first wavelength selection element disposed at a position where the first light is incident and having a reflective portion that reflects the first light and a transmissive portion that transmits the first light, the first wavelength selection element transmitting a second light having a second wavelength range different from the first wavelength range;
a light-collecting element disposed at a position to receive the first light reflected by the first wavelength selection element;
a second wavelength selection element that transmits or reflects, depending on its rotation state, the first light collected by the light-collecting element; and
a wavelength conversion element having a wavelength conversion segment that wavelength-converts the first light reflected by the second wavelength selection element into the second light, wherein the first light incidence on the second wavelength selection element and the first light reflected by the second wavelength selection element pass through spatially different positions in the light-collecting element.

2. A light source apparatus comprising:
a light source that emits a first light having a first wavelength range;
a first wavelength selection element disposed at a position where the first light is incident and having a reflective portion that reflects the first light and a transmissive portion that transmits the first light, the first wavelength selection element reflecting a second light having a second wavelength range different from the first wavelength range;
a light-collecting element disposed at a position to receive light transmitted through the first wavelength selection element;
a second wavelength selection element that transmits or reflects, depending on its rotation state, light collected by the light-collecting element; and
a wavelength conversion element having a wavelength conversion segment that wavelength-converts the first light reflected by the second wavelength selection element into the second light, wherein
the first light incidence on the second wavelength selection element and the first light reflected by the second wavelength selection element pass through spatially different positions in the light-collecting element.

3. The light source apparatus of claim 1, wherein
the second wavelength selection element includes:
a transmission segment that transmits the first light collected by the light-collecting element; and
a reflection segment that reflects the first light collected by the light-collecting element,
the light source apparatus comprising:
a first rotation drive that rotates the wavelength selection element;
a second rotation drive that rotates the wavelength conversion element; and
a controller that controls at least one of the second wavelength selection element and the wavelength conversion element so as to change the rotational phase.

4. The light source apparatus of claim 3, wherein
the controller controls the rotational phase positions of the wavelength conversion element and the second wavelength selection element in one of at least two rotation modes as a rotational phase position of the second wavelength selection element relative to the wavelength conversion element.

5. The light source apparatus of claim 3, wherein
the sum of angles of the reflection segments that reflect the first light around rotation center of the second wavelength selection element is equal to or less than the sum of angles of the wavelength conversion segments around a rotation center of the wavelength conversion element.

6. The light source apparatus of claim 1, wherein
in the first wavelength selection element, the reflective portions are arranged in a band shape.

7. The light source apparatus of claim 1, wherein
the second light includes, in a time-divided manner, light in at least two different wavelength ranges included in the second wavelength range, and wherein
the wavelength conversion element is excited by the first light and emits fluorescent light in at least two different wavelength ranges.

8. The light source apparatus of claim 7, wherein
the first light is blue laser light, wherein
the second light includes a third light having a third wavelength range included in the second wavelength range, wherein
the wavelength conversion element includes: a first phosphor segment that is excited by the first light and emits the second light as fluorescent light; and a second phosphor segment that is excited by the first light and emits the third light as fluorescent light, and wherein
the first phosphor segment is a yellow phosphor segment that emits yellow fluorescent light as the second light, and the second phosphor segment is a green phosphor segment that emits green fluorescent light as the third light.

9. The light source apparatus of claim 8, wherein
the second wavelength selection element includes a segment that transmits the second yellow fluorescent light as red light when the yellow second light is incident thereon.

10. A projection-type image display apparatus comprising the light source apparatus of claim 1.

11. The light source apparatus of claim 2, wherein
the second wavelength selection element includes:
a transmission segment that transmits the first light collected by the light-collecting element; and
a reflection segment that reflects the first light collected by the light-collecting element,
the light source apparatus comprising:
a first rotation drive that rotates the wavelength selection element;
a second rotation drive that rotates the wavelength conversion element; and
a controller that controls at least one of the second wavelength selection element and the wavelength conversion element so as to change the rotational phase.

12. The light source apparatus of claim 11, wherein
the controller controls the rotational phase positions of the wavelength conversion element and the second wavelength selection element in one of at least two rotation modes as a rotational phase position of the second wavelength selection element relative to the wavelength conversion element.

13. The light source apparatus of claim 11, wherein
the sum of angles of the reflection segments that reflect the first light around rotation center of the second wavelength selection element is equal to or less than the sum of angles of the wavelength conversion segments around a rotation center of the wavelength conversion element.

14. The light source apparatus of claim 2, wherein
in the first wavelength selection element, the reflective portions are arranged in a band shape.

15. The light source apparatus of claim 2, wherein
the second light includes, in a time-divided manner, light in at least two different wavelength ranges included in the second wavelength range, and wherein the wavelength conversion element is excited by the first light and emits fluorescent light in at least two different wavelength ranges.

16. The light source apparatus of claim 15, wherein
the first light is blue laser light, wherein
the second light includes a third light having a third wavelength range included in the second wavelength range, wherein
the wavelength conversion element includes: a first phosphor segment that is excited by the first light and emits the second light as fluorescent light; and a second phosphor segment that is excited by the first light and emits the third light as fluorescent light, and wherein
the first phosphor segment is a yellow phosphor segment that emits yellow fluorescent light as the second light, and the second phosphor segment is a green phosphor segment that emits green fluorescent light as the third light.

17. The light source apparatus of claim 16, wherein
the second wavelength selection element includes a segment that transmits the second yellow fluorescent light as red light when the yellow second light is incident thereon.

18. A projection-type image display apparatus comprising the light source apparatus of claim 2.
